(19) United States
(12) Patent Application Publication
(10) Pub. No.: US 2020/0128864 A1
(43) Pub. Date: Apr. 30, 2020

(54) EDIBLE, SHELF-STABLE, WATER-SOLUBLE OIL-IN-SYRUP EMULSIONS OF MICROPARTICLE-ENCAPSULATED CANNABINOIDS AND USES THEREOF

(71) Applicant: Emanuel Frank IV Petricoin, Gainesville, VA (US)

(72) Inventor: Emanuel Frank IV Petricoin, Gainesville, VA (US)

(21) Appl. No.: 16/661,896

(22) Filed: Oct. 23, 2019

Related U.S. Application Data
(60) Provisional application No. 62/749,835, filed on Oct. 24, 2018.

(51) Int. Cl. A23L 29/00; A23D 7/00; A23L 29/10; A23L 29/269; A23L 29/25; A23L 29/30

(52) U.S. Cl. CPC A23L 29/04; A23D 7/003; A23L 29/30; A23L 29/27; A23L 29/25; A23L 29/10

(57) ABSTRACT

Provided herein are edible, shelf-stable, water-soluble oil-in-syrup emulsions of cannabinoid microcapsules. The disclosed emulsions provide extended cannabinoid release and predictable and consistent blood plasma levels of cannabinoids upon ingestion. Also provided are methods for producing the disclosed emulsions.

### RELATED APPLICATION DATA

This application claims priority to U.S. Provisional Application No. 62/749,835, filed Oct. 24, 2018, the content of which is hereby incorporated by reference in its entirety for all purposes.

### FIELD

Edible, shelf-stable, water-soluble oil-in-syrup emulsions of liposome-encapsulated cannabinoids, which may be formulated as beverages and food ingredients are disclosed. The disclosed emulsions evenly mix, are soluble in water, have high bioavailability, provide predictable and consistent blood plasma levels of cannabinoids upon ingestion, and may be kept indefinitely without separation or coagulation of their components.

### BACKGROUND

Cannabinoids are lipophilic compounds derived from the annual plants Cannabis sativa, Cannabis indica, Cannabis ruderalis, and hybrids thereof, in the Cannabaceae family. Cannabis sativa contains more than 100 cannabinoids. The most active naturally occurring cannabinoid is tetrahydrocannabinol (THC), which is beneficial in the treatment of a wide range of medical conditions, including glaucoma, AIDS wasting, neuropathic pain, treatment of spasticity associated with multiple sclerosis, fibromyalgia, emesis and chemotherapy-induced nausea. Additionally, THC has been reported to exhibit a therapeutic effect in the treatment of allergies, inflammation, infection, epilepsy, depression, migraine, bipolar disorders, anxiety disorder, and drug dependency and withdrawal syndromes.

With the legalization of Cannabis markets, therapeutic and recreational uses of cannabinoids are increasing. In particular, oral ingestion of solid dosage forms and baked goods containing whole plant, plant extracts, or purified natural cannabinoids or analogous synthetic compounds, is common. However, the taste of the oral solid dosage forms and goods is not very palatable or appropriate in cases where individuals have trouble chewing or swallowing solids. In addition, because the cannabinoids in edible products are absorbed through the gastrointestinal (GI) tract, it may take a few hours for the solid dosage forms and baked goods to take effect, and there is a risk of overdosing for those users seeking a quick effect. Drink formulations containing cannabinoids provide faster effects. However, liquid beverage formulations often exhibit low bioavailability, as cannabinoids do not mix with water and do not dissolve well in the aqueous environment of the gastrointestinal tract because of their hydrophobic nature. Improving bioavailability of oral cannabinoid formulations by means of liposomal encapsulation is crucial, because consistent bioavailability enables consumers to effectively correlate their experience and perceived effects to a specific cannabinoid dosage, while minimizing overdosing.

One common practice to overcome these problems in cannabinoid beverage preparation is to infuse cannabinoids in oil and add water to create a two-phase drink, with the lipid phase being the upper or the lower phase. These types of formulations, however, are ingested all at once with the first sip, and no dosage can be established in in relation to the amount of beverage consumed. Another common practice, which consists in infusing cannabinoids in water-soluble syrup without liposomal encapsulation or any oil in the infusion, produces liquid formulations with poor bioavailability. Similarly, water emulsions of oil-infused cannabinoids tend to separate into two phases over time even where preservatives and stabilizers are added to the emulsion. Nano-emulsions of cannabinoids in water-based solutions, on the other hand, require the addition of expensive high-shear emulsifiers, stabilizers and preservatives, and yield formulations that provide short-lasting therapeutic effects and are quickly metabolized, as the nanoparticles in the emulsions easily move between cell membranes. In addition, nano-emulsions of cannabinoids are often bitter and unpalatable and are not suitable for extended release of cannabinoids. Finally, alcoholic cannabinoid beverages present ethical challenges, have unpopular taste and may present significant health risks.

Therefore, a need exists for cannabinoid liquid formulations for oral ingestion, which have improved water solubility, dissolution and taste, as well as enhanced bioavailability and absorption, and do not cause gastrointestinal irritation. There is a specific need for microparticle-sized liposomal formulations of cannabinoids that provide extended, long-lasting release of cannabinoids.

The present application presents a solution to the aforementioned challenge. In particular, the present inventor has successfully devised storage-stable oil-in-syrup emulsions comprising microparticles of cannabinoids and hydrophilic syrup. Formation of microparticles requires low shear force. Low shear force, however, may not be applied to low viscosity aqueous solutions, since water emulsions do not hold and the microparticles eventually separate or coagulate. Thus, unlike known technologies, which make use of high shear force and ultrasonic power to produce nanoparticles in water, the present inventor has developed a novel technology to generate stable cannabinoid microparticles, in which the use of hydrophilic syrup enables microparticle formation. Without being bound by any theory, the high viscosity hydrophilic syrup allows formation of liposome lipid bilayer structures, which encapsulate the cannabinoids. High viscosity syrups lower the required shear force to generate a stable emulsion, so larger, stable particles can be formed.

A large microparticle size increases the total oil capacity for lipophilic compounds, and prevents their movement between cell membranes. Because cannabinoids are lipophilic compounds, greater concentrations of payload can be loaded into microparticles. Moreover, since microparticles do not as easily pass through cell membranes, the disclosed cannabinoid microparticles remain in the system for longer periods of time and deliver cannabinoid payloads over a greater period of time than routinely used nanoparticles. Unlike unilamellar nanoparticles, which may not achieve extended release, the multilamellar structure of the disclosed microparticles allows extended release of multiple cannabinoid payloads.

The disclosed cannabinoid microparticles are stably emulsified, do not coagulate nor they separate from the emulsions, and provide extended release of the cannabinoid payload. As their size prevents the microparticles from freely move between cell membranes, the disclosed cannabinoid microparticles remain longer in the system after administration and deliver the cannabinoid payload over an extended period of time. The storage-stable oil-in-syrup emulsions provided herein do not spoil over time and can be consumed directly as syrup, mixed in a drink or serve as a platform for infusion of additional products.

### SUMMARY

It is shown herein that oil-in-syrup emulsions of cannabinoid microparticles evenly mix, have high bioavailability, provide long-lasting, extended release of cannabinoids, are soluble in water, and may be kept indefinitely without separation or coagulation of their components. Based on these findings, edible, shelf-stable, water-soluble oil-in-syrup emulsions of cannabinoid microparticles are provided. The disclosed stable oil-in-syrup emulsions provide extended release of the cannabinoid payload and predictable and consistent blood plasma levels of cannabinoids upon ingestion.

In some embodiments, the disclosed water-soluble, stable oil-in-syrup emulsions of cannabinoid microparticles comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

In some embodiments, the cannabinoid is one or more of a decarboxylated cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene and analogs thereof.

In some embodiments, the oil is medium-chain triglyceride oil. Suitable medium-chain triglyceride oils include, but are not limited to, one or more of coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil. Suitable emulsifiers include, but are not limited to, one or more of soy lecithin, sunflower lecithin, xantham gum, and gum Arabic.

In some embodiments, the water-soluble syrup is one or more of agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

In some embodiments, the cannabinoid is a decarboxylated cannabis extract; the oil is fractionated coconut oil; the emulsifier is soy lecithin; and the water-soluble syrup is agave nectar.

Also provided herein are compositions comprising the disclosed edible shelf stable, water-soluble oil-in-syrup emulsions of cannabinoid microparticles.

In some embodiments, the water-soluble, stable oil-in-syrup emulsions of cannabinoid microparticles in the disclosed compositions comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

Suitable cannabinoids include, but are not limited to, one or more of a decarboxylated cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene and analogs thereof.

In some embodiments, the oil is medium-chain triglyceride oil. Suitable medium-chain triglyceride oils include, but are not limited to, one or more of coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil. Suitable emulsifiers include, but are not limited to, one or more of soy lecithin, sunflower lecithin, xantham gum, and gum Arabic.

In some embodiments, the water-soluble syrup is one or more of agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

In some embodiments, the cannabinoid is a decarboxylated cannabis extract; the oil is fractionated coconut oil; the emulsifier is soy lecithin; and the water-soluble syrup is agave nectar.

In some embodiments, the oil-in-syrup emulsions in the disclosed compositions comprise 15% (vol/vol) of coconut oil, 1.5% (vol/vol) of a decarboxylated cannabinoid extract, 0.01-5% (vol/vol) of soy lecithin, and 80-85% (vol/vol) of agave nectar.

In some embodiments, the disclosed compositions are Newtonian fluids in form of food ingredients or beverages.

In some embodiments, the disclosed compositions are in form of beverages. Suitable beverages include, but are not limited to, a syrup, a yogurt drink, a milk-based drink, a milkshake, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

In additional embodiments, provided herein are kits, which comprise the disclosed edible shelf stable, water-soluble oil-in-syrup emulsions of cannabinoid microparticles, a container, a measuring tool and instructions for use. In some examples, the container is a bottle, a jar, a flask, a dispenser, a thermos, a carafe or a hermetic seal glass pitcher with a lid and spout. In some examples, the measuring tool is a measuring spoon, a metered dropper pipette, a volumetric cylinder, a volumetric flask, or a measuring cup.

In yet another embodiment, provided herein is a process of preparing the disclosed edible shelf-stable, water-soluble oil-in-syrup emulsion of cannabinoid microparticles. In some embodiments, the disclosed process comprises: (1) obtaining a cannabinoid; (2) mixing an emulsifier and an oil into a mixture and heating the mixture until the emulsifier is completely dissolved in the oil; (3) cooling the mixture to about 70° C.; (4) adding the cannabinoid to the mixture, and stirring the mixture until the cannabinoid is fully dissolved in the mixture; (5) heating a water-soluble syrup from about 35° C. to about 115° C. and blending the syrup while adding the mixture comprising the oil, emulsifier and cannabinoid to the syrup to produce an oil-in-syrup emulsion comprising microparticles of cannabinoids; (6) blending the emulsion for about 5 seconds to about 10 minutes at a temperature from about 35° C. to about 115° C.; and (7) cooling the emulsion at room temperature.

In some embodiments, the disclosed process may further comprise decarboxylating the cannabinoid by heating the cannabinoid at a temperature between about 90° C. and about 115° C. for about 20 to 25 minutes, and cooling the cannabinoid to a temperature between about 20° C. and 25° C. before adding the cannabinoid to the mixture comprising the emulsifier dissolved in oil.

In some embodiments, the water-soluble syrup and the mixture comprising the oil, emulsifier and cannabinoid are blended in a ratio from about 51:49 (vol/vol) to about 99:1 (vol/vol). In some embodiments, the water-soluble syrup and the mixture comprising the oil, emulsifier and cannabinoid are blended in a ratio of about 85:15 (vol/vol).

In some embodiments, the water-soluble, stable oil-in-syrup emulsions of cannabinoid microparticles thus produced comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions of cannabinoid microparticles thus produced comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions of cannabinoid microparticles thus produced comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

In some embodiments, the cannabinoid is one or more of a decarboxylated cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene and analogs thereof.

In some embodiments, the oil is medium-chain triglyceride oil. Suitable medium-chain triglyceride oils include, but are not limited to, one or more of coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil. Suitable emulsifiers include, but are not limited to, one or more of soy lecithin, sunflower lecithin, xantham gum, and gum Arabic.

In some embodiments, the water-soluble syrup is one or more of agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

In some embodiments, the cannabinoid is a decarboxylated cannabis extract; the oil is fractionated coconut oil; the emulsifier is soy lecithin; and the water-soluble syrup is agave nectar.

In some embodiments, the emulsion is cloudy and opaque. In some embodiments, the emulsion may remain cloudy and opaque indefinitely.

In some embodiments, the disclosed process may further comprise adding the oil-in-syrup emulsion as a food or beverage ingredient to a composition to produce a food or beverage product. Suitable food products include, but are not limited to, one or more of a dairy product, yoghurt, an ice cream, a pudding, a nutrition bar, a cracker, a cookie, or a biscuit. Suitable beverages include, but are not limited to, a syrup, a yogurt drink, a milk-based drink, a milkshake, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

In yet another embodiment, provided herein is a method for providing or maintaining extended release of a cannabinoid payload and a predictable and consistent blood plasma level of cannabinoids in a subject. The method comprises orally administering to the subject a composition comprising the disclosed stable oil-in-syrup emulsion.

In some embodiments, the composition is a Newtonian fluid in form of a beverage. Suitable beverages include, but are not limited to, a syrup, a yogurt drink, a milk-based drink, a milkshake, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

In some embodiments, the water-soluble, stable oil-in-syrup emulsions of cannabinoid microparticles in the disclosed compositions comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

In some embodiments, the cannabinoid is one or more of a decarboxylated cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene and analogs thereof.

In some embodiments, the oil is medium-chain triglyceride oil. Suitable medium-chain triglyceride oils include, but are not limited to, one or more of coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil. Suitable emulsifiers include, but are not limited to, one or more of soy lecithin, sunflower lecithin, xantham gum, and gum Arabic.

In some embodiments, the water-soluble syrup is one or more of agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

In some embodiments, the cannabinoid is a decarboxylated cannabis extract; the oil is fractionated coconut oil; the emulsifier is soy lecithin; and the water-soluble syrup is agave nectar.

In some embodiments, the disclosed compositions comprise 15% (vol/vol) of coconut oil, 1-1.5% (vol/vol) of a decarboxylated cannabis extract, 3-5% (vol/vol) of soy lecithin, and 80-90% (vol/vol) of agave nectar.

In some embodiments, the beverage is administered to the subject once a day, twice a day, three times a day, or more than three times a day.

In some embodiments, the beverage comprises from about 1 mg cannabinoid/ml beverage to about 1,000 mg cannabinoid/ml beverage. In some embodiments, the beverage comprises about 10 mg cannabinoid/ml beverage.

In some embodiments, the subject is a mammal. In some embodiments, the subject is a human subject. In some embodiments, the human subject is a cannabis recreational user. In some embodiments, the human subject is a cannabis medical user.

The stable oil-in-syrup emulsions of cannabinoid microparticles and compositions provided herein present several attractive features and desirable properties that make them suitable for recreational and medical use. For example, the disclosed water-soluble oil-in-syrup emulsions of cannabinoid microparticles and compositions do not contain alcohol and their doses can be easily titrated and administered by extended release. The disclosed emulsions of cannabinoid microparticles remain longer in the system after administration and deliver the cannabinoid payload over an extended period of time. Therefore, the disclosed water-soluble oil-in-syrup emulsions of cannabinoid microparticles achieve the desired effect, because they provide the user with extended release of the cannabinoid payload and predictable and consistent blood plasma levels of cannabinoids upon ingestion, present no risk of accidental overdoses, and do not cause any aversive experience.

Moreover, the disclosed oil-in-syrup emulsions of cannabinoid microparticles evenly mix in drinks, have high bioavailability, are soluble in water, have pleasant taste and are palatable, and may be kept indefinitely without separation or coagulation of their components.

In addition, the disclosed oil-in-syrup emulsions of cannabinoid microparticles may be easily manufactured, bottled, packaged in food-safe containers and distributed without risk of spoilage or separation. Therefore, the disclosed oil-in-syrup emulsions of cannabinoid microparticles may serve as a platform to infuse drinks for direct consumption, bottling and distribution.

The foregoing and other features of the disclosure will become more apparent from the following detailed description of several embodiments, which proceeds with reference to the accompanying figures.

### BRIEF DESCRIPTION OF THE FIGURES

FIG. 1 shows a beaker containing 100 ml of agave nectar, a water-soluble syrup used as the continuous phase in the disclosed oil-in-syrup emulsions of cannabinoids.

FIG. 2 shows a beaker containing 15 ml of medium-chain triglyceride oil, an oil used as the dispersed phase in the disclosed oil-in-syrup emulsions of cannabinoids.

FIG. 3 shows a beaker containing 2 ml of liquid soy lecithin, an emulsifier used to prevent separation of the continuous phase and the dispersed phase in the disclosed oil-in-syrup emulsions of liposome-encapsulated cannabinoids. The soy lecithin emulsifier and the medium-chain triglyceride oil produce liposome-encapsulated cannabinoids.

FIG. 4 shows a beaker containing a mixture of a medium-chain triglyceride oil and liquid soy lecithin prior to addition of a cannabinoid.

FIG. 5 shows the heating of a mixture of a medium-chain triglyceride oil and liquid soy lecithin by double boiler method prior to addition of a cannabinoid. The emulsifier is completely dissolved in the oil.

FIG. 6 shows a container in which a decarboxylated cannabis extract is added to a mixture of a medium-chain triglyceride oil and liquid soy lecithin.

FIG. 7 shows a beaker containing a decarboxylated cannabis extract completely dissolved in a mixture of a medium-chain triglyceride oil and liquid soy lecithin. The cannabinoids are now liposome-encapsulated and bioavailable.

FIG. 8 shows a step in the preparation of the disclosed oil-in-syrup emulsions of cannabinoids, in which the water-soluble syrup is heated to about 70° C. and blended with an immersion blender while slowly and gradually adding the mixture comprising the oil, emulsifier and cannabinoid to the syrup to produce an oil-in-syrup emulsion.

FIG. 9 shows the oil-in-syrup emulsion of cannabinoids obtained at the end of the blending process with the immersion blender. The syrup continuous phase and the oil-dispersed phase are blended together into a stable oil-in-syrup emulsion.

FIG. 10 shows the oil-in-syrup emulsion of cannabinoids after pouring the emulsion into a couple of containers and cooling the emulsion at room temperature. The oil-in-syrup emulsion is stable and it remains cloudy and opaque indefinitely.

### DETAILED DESCRIPTION

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. For example, reference to “comprising a therapeutic agent” includes one or a plurality of such therapeutic agents. The term “or” refers to a single element of stated alternative elements or a combination of two or more elements, unless the context clearly indicates otherwise. For example, the phrase “A or B” refers to A, B, or a combination of both A and B. Furthermore, the various elements, features and steps discussed herein, as well as other known equivalents for each such element, feature or step, can be mixed and matched by one of ordinary skill in this art to perform methods in accordance with principles described herein. Among the various elements, features, and steps some will be specifically included and others specifically excluded in particular examples.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. All references cited herein are incorporated by reference in their entirety.

In some examples, the numbers expressing quantities of ingredients, properties such as molecular weight, reaction conditions, and so forth, used to describe and claim certain embodiments are to be understood as being modified in some instances by the term “about” or “approximately.” For example, “about” or “approximately” can indicate +/− 20% variation of the value it describes. Accordingly, in some embodiments, the numerical parameters set forth herein are approximations that can vary depending upon the desired properties for a particular embodiment. Notwithstanding that the numerical ranges and parameters setting forth the broad scope of some examples are approximations, the numerical values set forth in the specific examples are reported as precisely as practicable. The recitation of ranges of values herein is merely intended to serve as a shorthand method of referring individually to each separate value falling within the range.

To facilitate review of the various embodiments of this disclosure, the following explanations of specific terms are provided:

Administer: To provide or give a subject a composition, such as a supplement composition, by an effective route. Application is local. Exemplary routes of application include, but are not limited to, oral and topical routes.

Analog: A compound having a structure similar to another, but differing from it, for example, in one or more atoms, functional groups, or substructure. Thus, cannabinoid analogs encompass compounds that are structurally related to naturally occurring cannabinoids, but whose chemical and biological properties may differ from naturally occurring cannabinoids, as well as compounds derived from a naturally occurring cannabinoid by chemical, biological or a semi-synthetic transformation of the naturally occurring cannabinoid. Analogs also include compounds having a structure similar to one or more naturally occurring cannabinoids, and exhibiting no undesirable side effects or reduced undesirable side effects as compared to the one or more naturally occurring cannabinoids.

Antagonist: A molecule that, upon binding to a cell receptor, competes and/or interferes with one or more ligands binding the same receptor, and thus reduces or prevents a response elicited by those ligands.

Cannabinoids: A class of diverse chemical compounds that activate cannabinoid receptors. Cannabinoids produced by plants are called phytocannabinoids. Typical cannabinoids isolated from the Cannabis plants include, but are not limited to, Tetrahydrocannabinol (THC), Cannabidiol (CBD), CBG (Cannabigerol), CBC (Cannabichromene), CBL (Cannabicyclol), CBV (Cannabivarin), THCV (Tetrahydrocannabivarin), CBDV (Cannabidivarin), CBCV (Cannabichromevarin), CBGV (Cannabigerovarin), and CBGM (Cannabigerol Monomethyl Ether). In the Cannabis plant, cannabinoids are synthesized and accumulated as cannabinoid acids. When the herbal product is dried, stored, or heated, the acids decarboxylize gradually or completely into their corresponding neutral forms (CBDA→CBD). THC is the principal psychoactive constituent of the Cannabis plants. It has mild to moderate analgesic and antiemetic effects, and it may cause relaxation, alteration of visual, auditory, and olfactory senses, fatigue, and appetite stimulation. Cannabidiol increases alertness, and attenuates the memory-impairing effect of THC. Cannabidiol relieves convulsion, inflammation, anxiety, and nausea, and it seems to inhibit cancer cell growth. Unlike THC, cannabidiol has no affinity for CB₁ and CB₂ receptors but acts as an indirect antagonist of cannabinoid agonists. Cannabigerol is found in higher concentrations in hemp, and it has been shown to relieve intraocular pressure. Cannabichromene seems to play a role in the anti-inflammatory and anti-viral effects of Cannabis, and may contribute to the overall analgesic effects of medical Cannabis. Cannabivarin is a non-psychoactive cannabinoid found in minor amounts in Cannabis sativa.

Contacting: Placement in direct physical association; includes both in solid and liquid form.

Control: A reference standard. In some examples, a control is a known value or range of values, such as one indicative of the presence or the absence of a disease. In some examples, a control is a value or range of values, indicating a response in the absence of an active agent.

Effective amount: The amount of an active agent (alone or with one or more other active agents) sufficient to induce a desired response, such as to prevent, treat, reduce and/or ameliorate a condition. Effective amounts of an active agent, alone or with one or more other active agents, can be determined in many different ways, such as assaying for a reduction in of one or more signs or symptoms associated with the condition in the subject or measuring the level of one or more molecules associated with the condition to be treated.

Emulsifier: A surfactant that reduces the interfacial tension between oil and water, minimizing the surface energy through formation of globules. Emulsifiers include gums, fatty acid conjugates and cationic, anionic and amphotheric surfactants capable of suspending the oily phase and stabilizing the emulsion by coating the oil droplets and avoiding the separation of the internal oily phase. The film coat produced by the emulsifier is a barrier between the immiscible phase and it also prevents droplets association, coagulation and coalescence. Examples of emulsifier include, but are not limited to, lecithin, glyceryl monostearate, methylcellulose, sodium lauryl sulfate, sodium oleate, sorbitan monopalmitate, sorbitan monostearate, sorbitan tristrearate, tragacanth, triethanolamine oleate, polyethylene sorbitan monolaurate, poloxamer, detergents, Tween 80 (polyoxyethylene sorbitan monooleate), Tween 20 (polyoxyethylene sorbitan monolaurate), cetearyl glucoside, polyglucosides, sorbitan monooleate (Span 80), sorbitan monolaurate (Span 20), polyoxyethylene monostearate (Myrj 45), polyoxyethylene vegetable oil (Emulphor), cetyl piridinium chloride, polysaccharides gums, Xanthan gums, Tragacanth, Gum arabica, Acacia, or proteins and conjugated proteins capable of forming and protecting stable oil in glycerin emulsion.

Emulsion: A thermodynamically unstable dispersion system containing two immiscible liquids. The liquid that constitutes the internal or external phases determines the types of emulsions. In oil-in-water emulsions the oil is the dispersed phase, and water is the external phase. In water-in-oil emulsions water is the dispersed phase and oil is the external phase. Instability in emulsions is due to flocculation, where the attractive force between droplets drives floc formation; creaming, where buoyancy or centripetal force drive droplet migration to the surface of the emulsion; coalescence, where droplets combine to form larger droplets; or Ostwald ripening, where droplets redeposit as larger crystals.

Fat: Fats, also known as triglycerides, are esters of three fatty acid chains and the alcohol glycerol, and they are typically solid at room temperature. Fats are generally hydrophobic, and are soluble in organic solvents and insoluble in water. Fats serve structural and metabolic functions. Saturated fats have no double bonds between the carbons in the chain, whereas unsaturated fats have one or more double bonded carbons in the chain. Fats are broken down in the healthy body to release glycerol, which may be converted to glucose in the liver, and fatty acids. Vitamins A, D, E and K are fat-soluble, and fats play a vital role in maintaining healthy skin and hair, insulating body organs against shock, maintaining body temperature, and promoting healthy cell function. In animals, fat is stored in the adipose tissue, a connective tissue consisting mainly of adipocytes, which synthesize and contain large globules of fat within a structural network of fibers. Adipocytes may degrade the stored fat to supply fatty acids and glycerol to the circulation. In mammals, adipose tissue is found mainly under the skin but also in deposits between the muscles, in the intestines, around the heart and in the bone marrow. The fat stored in adipose tissue comes from dietary fats or is produced in the body. Mammals have different types of adipose tissue. White adipose tissue (WAT) provides insulation, serves as an energy store for times of starvation or great exertion, and forms pads between organs. The dermal WAT (DWAT) is subjacent to the dermis and accumulates in response to cold temperature, hair growth and bacterial infection. When muscles and other tissues need energy, lipase enzymes are activated by the hormones epinephrine, norepinephrine, glucagon, and adrenocorticotropin, which bind to the adipocytes, and hydrolysis of triacylglycerol is triggered, resulting in the release of energy-rich fatty acids and glycerol—a process known as lipolysis. The brown adipose tissue generates heat, consumes energy, and it is enriched in mitochondria. Abnormalities in the metabolism of adipose tissue are strongly correlated with diseases, such as obesity, diabetes mellitus and cardiovascular diseases. Visceral fat is located within the abdominal wall and subcutaneous fat is located beneath the skin.

Hydrophilic: A polymer, substance or compound that is capable of absorbing more than 10%/w of water at 100% relative humidity (RH).

Hydrophobic: A polymer, substance or compound that is capable of absorbing no more than 1%/w of water at 100% relative humidity (RH).

Hygroscopic: A polymer, substance or compound that is capable of absorbing more than 20 w % of water at 100% relative humidity (RH).

Inhibiting a condition: Reducing, slowing, or even stopping the development of a condition, for example, in a subject who is at risk of developing or has a particular condition.

Lipophilic: A substance or compound that has an affinity for a non-polar environment compared to a polar or aqueous environment.

Liposome: A spherical vesicle containing one or more lipid bilayers composed of phospholipids, such as phosphatidylcholine and phoshatidylethanolamine, that surround a hydrophilic core. Liposomes can be used as vehicles for transport of nutrients and drugs, and can be prepared by sonication of biological membranes.

Localized application: The application of an active agent in a particular location in the body.

Medium Chain Triglyceride (MCT) Oil: Triglycerides comprising fatty acids having an aliphatic chain of 6-12 carbon atoms. MCTs passively diffuse from the GI tract to the venous portal system with no modification, and they do not require bile acids for digestion.

Newtonian Fluid: A fluid that behaves according to Newton's law, with a viscosity μ that is independent of stress, and with a linear relationship between stress and strain rate. Although viscosity changes with temperature, it does not change with the strain rate.

Nutraceutical: A pharmaceutical-grade and standardized nutrient, dietary supplement or food additive.

Oil: Any fatty substance that is in viscous liquid form at room temperature (25° C.) and at atmospheric pressure (760 mmHg). Oils are hydrophobic and lipophilic, have a high carbon and hydrogen content and are usually flammable and surface active. Oils may be animal, vegetable, or petrochemical in origin, and may be volatile or non-volatile. Oils may be used for food, fuel, medical purposes, and for the manufacture of paints and plastics. Edible oil is plant, animal, or synthetic fat used in frying, baking, as well as in salad dressings and bread dips. Edible oil is typically liquid at room temperature, although some oils that contain saturated fat are solid, such as coconut oil, palm oil and palm kernel oil. Edible oils include, but are not limited to, olive oil, palm oil, soybean oil, canola oil, rapeseed oil, corn oil, peanut oil, cotton oil, avocado oil, vegetable oils, and animal-based oils, such as butter and lard.

Oral administration: Delivery of an active agent through the mouth.

Organoleptic: A property of an edible substance or liquid that an individual experiences via the senses, including taste, sight, smell, and touch.

Permeation Enhancer: A natural or synthetic molecule that facilitates the transport of co-administered active agents across biological membranes.

pH Adjuster or Modifier: A molecule or buffer used to achieve desired pH control in a formulation. Exemplary pH modifiers include acids (e.g., acetic acid, adipic acid, carbonic acid, citric acid, fumaric acid, phosphoric acid, sorbic acid, succinic acid, tartaric acid, basic pH modifiers (e.g., magnesium oxide, tribasic potassium phosphate), and pharmaceutically acceptable salts thereof.

Recreational Drug Use: The use of a psychoactive drug that causes an intoxicating effect to induce an altered state of consciousness for pleasure, by modifying the perceptions, feelings, and emotions of the user.

Subject: A living multi-cellular vertebrate organism, a category that includes human and non-human mammals, as well as birds (such as chickens and turkeys), fish, and reptiles. Exemplary subjects include mammals, such as human and non-human primates, rats, mice, dogs, cats, rabbits, cows, pigs, goats, horses, and the like.

Syrup: A thick, viscous liquid consisting primarily of a solution of sugar in water, and containing a large amount of dissolved sugars but showing little tendency to deposit crystals. The high viscosity is due to the formation of hydrogen bonds between the hydroxyl groups of the sugar and the water. Exemplary syrups include, but are not limited to, corn syrup, sorghum juice, maple syrup, glucose syrup, cane syrup, simple syrup, gum Arabic, honey, barley malt syrup, birch syrup, brown rice syrup, chocolate syrup, fruit syrup, grape syrup, grenadine, honey, kithul treacle, meringue, orgeat syrup, palm syrup, sharbat, stevia, sugar beet syrup, syrup of maidenhair, torani, treacle, yacon syrup, fructose, oligofructose, agave nectar, plant nectar, sorbitol, mannitol, xylitol, isomalt, arabitol, lacitol, xylitol, sucrose, maltitol, hydrogenated starch hydro lysates, glycerol, and any combinations thereof.

Under conditions sufficient to: A phrase that is used to describe any environment that permits the desired activity.

Viscosity: The measure of a fluid's resistance to gradual deformation by shear stress or tensile stress.

Water-Insoluble: A polymer, compound or composition which has a solubility in water of less than 5%/w, less than 3%/w, or less than 1%/w, measured in water at 20° C.

Water-Swellable: A polymer, substance or compound that is capable of absorbing an amount of water greater than at least 25%/w of its own weight, or greater than at least 50%/w, upon immersion in an aqueous medium.

### Edible Shelf-Stable, Water-Soluble Oil-In-Syrup Emulsions of Liposome-Encapsulated Cannabinoids and Compositions and Kits Thereof

Edible, shelf-stable, water-soluble oil-in-syrup emulsions of cannabinoid microcapsules are disclosed. Cannabinoids are lipophilic compounds obtained from the annual plants Cannabis sativa, Cannabis indica, Cannabis ruderalis, and hybrids thereof, in the Cannabaceae family. Cannabis sativa contains more than 100 different cannabinoids. The disclosed oil-in-syrup emulsions provided extended release of cannabinoids over time, are water-soluble and may be consumed directly, or can be mixed with milk, coffee, juices, carbonated water or other liquid to produce infused drinks. Once added to a beverage and stirred or agitated, the disclosed oil-in-syrup emulsions evenly mix and effectively infuse the beverage evenly, without separating or coagulating.

In some embodiments, the water-soluble, stable oil-in-syrup emulsions of cannabinoid microparticles provided herein comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions of cannabinoid microparticles provided herein comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions of cannabinoid microparticles provided herein comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

The disclosed dispersed phase: continuous phase ratio ranges ensure that the oil-in-syrup emulsion remains stable for extended periods of time and even indefinitely.

The particular combination of an oil dispersed phase and a syrup continuous phase extends the bioavailability of the disclosed emulsions, such that once they are orally ingested, they provide extended release of cannabinoid payload and predictable and consistent blood plasma levels of cannabinoids. Moreover, the disclosed oil-in-syrup emulsions do not contain alcohol and their doses can be easily titrated. Therefore, the disclosed water-soluble oil-in-syrup emulsions of cannabinoid microcapsules present no risk of accidental overdoses, and do not cause any aversive experience.

Exemplary cannabinoids include, but are not limited to, a decarboxylated cannabis extract, cannabis oil, a cannabis rosin, a cannabis resin, a cannabis trichome, a cannabis distillate, a cannabis isolate, delta-9-tetrahydrocannabinol, cannabidiol, cannabigerol, cannabichromene, and analogs thereof. Cannabinoids may be decarboxylated prior to addition to the emulsion.

In some embodiments, the oil is medium-chain triglyceride oil. Exemplary medium-chain triglyceride oils include, but are not limited to, coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil.

Exemplary emulsifiers include, but are not limited to, soy lecithin, sunflower lecithin, xantham gum, and gum Arabic.

Exemplary water-soluble syrups include, but are not limited to, agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

In some embodiments, the disclosed oil-in-syrup emulsion may comprise fractionated coconut oil, decarboxylated cannabis extract and soy lecithin as the dispersed phase, and a continuous phase comprising agave nectar. In some embodiments, the oil-in-syrup emulsion may comprise 15% (vol/vol) of fractionated coconut oil; 1.5% (vol/vol) of a decarboxylated cannabinoid extract; 0.01-5% (vol/vol) of soy lecithin; and 80-85% (vol/vol) of agave nectar.

The disclosed edible, shelf-stable, water-soluble oil-in-syrup emulsions of cannabinoid microcapsules may be formulated into compositions. The compositions may be Newtonian fluids in form of food ingredients or beverages.

In some embodiments, the disclosed compositions are in form of beverage. Exemplary beverages include, but are not limited to, a syrup, a yogurt drink, a milk-based drink, a milkshake, a tea, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

In some embodiments, the disclosed compositions are in form of a food ingredient, which can be added to a composition to produce a food product. Exemplary food products may include, but are not limited to, dairy products, yoghurts, ice creams, puddings, nutrition bars, crackers, cookies, and biscuits.

Also provided herein are kits, which comprise the disclosed edible shelf stable, water-soluble oil-in-syrup emulsion of cannabinoid microcapsules, a container, a measuring tool and instructions for use. Exemplary containers include, but are not limited to, a bottle, a jar, a flask, a dispenser, a thermos, a carafe and a hermetic seal glass pitcher with a lid and spout. Exemplary measuring tools include, but are not limited to, a measuring spoon, a metered dropper pipette, a volumetric cylinder, a volumetric flask, or a measuring cup.

### Methods of Producing the Disclosed Edible Shelf-Stable, Water-Soluble Oil-In-Syrup Emulsions of Cannabinoid Microcapsules and Compositions Thereof

Also provided herein is a process of preparing the disclosed edible, shelf-stable, water-soluble oil-in-syrup emulsions of cannabinoid microcapsules. The process comprises: (1) obtaining a cannabinoid; (2) mixing an emulsifier and an oil into a mixture and heating the mixture until the emulsifier is completely dissolved in the oil; (3) cooling the mixture to about 70° C.; (4) adding the cannabinoid to the mixture, and stirring the mixture until the cannabinoid is fully dissolved in the mixture; (5) heating a water-soluble syrup to a temperature from about 35° C. to about 115° C., blending the syrup and adding the mixture comprising the oil, emulsifier and cannabinoid to the syrup to produce an oil-in-syrup emulsion; (6) blending the emulsion for a period of time from about 5 seconds to about 10 minutes at 35° C.-115° C.; and (7) cooling the emulsion at room temperature.

To convert a cannabinoid acid into the corresponding cannabinoid, the disclosed process may further comprise decarboxylating the cannabinoid acid by heating the cannabinoid at a temperature between about 90° C. and about 115° C. for about 20 to 25 minutes, and cooling the cannabinoid to a temperature between about 20° C. and 25° C., before adding the cannabinoid to the mixture comprising the emulsifier dissolved in oil.

The water-soluble syrup and the mixture comprising the oil, emulsifier and cannabinoid may be blended in a ratio from about 51:49 (vol/vol) to about 99:1 (vol/vol). In some embodiments, the water-soluble syrup and the mixture comprising the oil, emulsifier and cannabinoid may be blended in a ratio of about 85:15 (vol/vol). Blending may be done by hand, mixer, emulsifier, homogenizer, or blender, such as an immersion blender.

The oil-in-syrup emulsions thus produced comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In other embodiments, the disclosed water-soluble, stable oil-in-syrup emulsions thus produced comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In yet other embodiments, the disclosed water-soluble, stable oil-in-syrup emulsions of cannabinoid microparticles comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

The low shear force used to form the emulsion produces liposomal micro-encapsulation of the cannabinoids. Thus, unlike other methods currently used in the art, where nanoparticles generated using high shear force or ultrasonic directly into water do not stay emulsified and slowly coagulate and separate, the process disclosed herein utilizes low shear force and high viscosity hydrophilic syrups to produce microparticles, which remain stably emulsified and provide extended release of cannabinoid payload. Moreover, the cannabinoid microparticles thus produced have extended bioavailability.

The ratios between the various ingredients are essential factors that determine the properties and the stability of the disclosed cannabinoid emulsions. The inventor has surprisingly found that compositions of oil-in-syrup emulsions comprising the same ingredients in ratios outside the claimed ratio ranges are not stable, as these compositions do not stay emulsified when left at room temperature for 24 hours or longer, and/or loose their emulsion status once they are added to a beverage for consumption. In contrast, the cannabinoid emulsions produced by the disclosed method are stable for prolonged periods of time, and even indefinitely. Moreover, the disclosed cannabinoid emulsions are cloudy and opaque, and may remain cloudy and opaque indefinitely.

Exemplary cannabinoids that may be used in the disclosed process include, but are not limited to, a cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene, and any analog thereof.

In some embodiments, the oil used in the disclosed process is medium-chain triglyceride oil. Exemplary medium-chain triglyceride oils include, but are not limited to, coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil.

Exemplary emulsifiers that may be used in the disclosed process include, but are not limited to, soy lecithin, sunflower lecithin, xantham gum, and gum Arabic.

Exemplary water-soluble syrups that may be used in the disclosed process include, but are not limited to, agave nectar, vegetable glycerin, honey, corn syrup, sorghum juice, maple syrup, glucose syrup, cane syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

Exemplary edible shelf-stable, water-soluble oil-in-syrup emulsions of cannabinoid microcapsules produced by the method provided herein may comprise a decarboxylated cannabis extract, fractionated coconut oil, soy lecithin, and agave nectar, wherein the dispersed phase comprises fractionated coconut oil in an amount of 15% (vol/vol), 1-1.5% (vol/vol) of a decarboxylated cannabis extract and 3-5% (vol/vol) of soy lecithin; and the continuous phase comprises 80-90% (vol/vol) of agave nectar.

The disclosed process may further comprise adding the oil-in-syrup emulsion as a food or beverage ingredient to a composition to produce a food product or a beverage. Exemplary food products include, but are not limited to, dairy products, yoghurts, ice creams, puddings, nutrition bars, crackers, cookies, and biscuits.

Exemplary beverages include, but are not limited to, a syrup, a yogurt drink, a milk-based drink, a milkshake, an ice tea, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

### Methods of Use of Compositions Comprising the Disclosed Edible Shelf-Stable, Water-Soluble Oil-In-Syrup Emulsions of Cannabinoid Microcapsules

Also provided herein is a method for providing or maintaining extended cannabinoid release and predictable and consistent blood plasma level of cannabinoids in a subject. The method comprises orally administering to the subject a composition comprising the disclosed stable oil-in-syrup emulsion of cannabinoid microcapsules.

In some embodiments, the composition is a Newtonian fluid in form of a beverage. Exemplary beverages include, but are not limited to, a syrup, a yogurt drink, a milk-based drink, a milkshake, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

In some embodiments, the water-soluble, stable oil-in-syrup emulsions of cannabinoid microparticles in the disclosed compositions comprise 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and 51-99.9% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

In some embodiments, the disclosed water-soluble, stable oil-in-syrup emulsions of cannabinoid microparticles in the disclosed compositions comprise 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

Exemplary cannabinoids include, but are not limited to, a cannabis extract, a cannabis oil, a cannabis rosin, a cannabis resin, a cannabis trichome, a cannabis distillate, a cannabis isolate, delta-9-tetrahydrocannabinol, cannabidiol, cannabigerol, cannabichromene, and any analog thereof.

In some embodiments, the oil is medium-chain triglyceride oil. Exemplary medium-chain triglyceride oils include, but are not limited to, coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil and corn oil.

Exemplary emulsifiers include, but are not limited to, soy lecithin, sunflower lecithin, xantham gum, and gum Arabic.

Exemplary water-soluble syrups include, but are not limited to, agave nectar, vegetable glycerin, honey, corn syrup, sorghum juice, maple syrup, glucose syrup, cane syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

Exemplary edible shelf-stable, water-soluble oil-in-syrup emulsions of cannabinoid microcapsules administered according to the disclosed method may comprise 1-1.5% (vol/vol) of a decarboxylated cannabis extract, 15% (vol/vol) of fractionated coconut oil, 3-5% (vol/vol) of soy lecithin, and 80-90% (vol/vol) of agave nectar.

In some embodiments, the disclosed compositions are in form of a food ingredient, which may be added to a composition to produce a food product. Exemplary food products include, but are not limited to, dairy products, yoghurts, ice creams, puddings, nutrition bars, crackers, cookies, and biscuits.

The disclosed compositions may be administered as beverages to the subject once a day, twice a day, three times a day, or more than three times a day, in an effective amount from about 1 mg cannabinoid/ml beverage to about 490 mg cannabinoid/ml beverage. For example, the beverage may comprise about 10 mg cannabinoid/ml beverage. The subject may be a mammal, such as a human subject. In some examples, the human subject may be a cannabis recreational user. In some embodiments, the human subject is a cannabis medical user.

The methods provided herein present many advantages that make them suitable for providing or maintaining a predictable and consistent blood plasma level of cannabinoids in recreational and medical cannabinoid users. The disclosed methods make use of stable oil-in-syrup emulsions of cannabinoid microcapsules and compositions that remain in the system and provide release of cannabinoids for an extended period of time, do not contain alcohol and can be easily titrated for dosage. Therefore, the disclosed water-soluble oil-in-syrup emulsions of cannabinoid microcapsules achieve the desired effect without risk of accidental overdoses, or aversive experiences.

Moreover, the disclosed oil-in-syrup emulsions of cannabinoid microcapsules are soluble in water, and thus evenly mix in drinks, have high bioavailability, have pleasant taste and may be kept indefinitely without separation or coagulation of their components.

Because of their exceptional stability, the disclosed oil-in-syrup emulsions of cannabinoid microparticles are easily manufactured, bottled, packaged in food-safe containers and consumed, or distributed without risk of spoilage or separation.

### EXAMPLES

### Example 1

### Preparation of Cannabinoid-Infused Oil-In-Syrup Emulsions

A. Decarboxylation

5 ml of a cannabis extract obtained from Cannabis sativa were heated at about 95° C. for about 20 minutes until melted, and then placed in a freezer for 15 minutes to cool.

10 ml of cannabis rosin extract obtained from Cannabis sativa were heated with no solvent at about 95° C. for about 20 minutes until melted, and then placed in a freezer for 15 minutes to cool.

B. Dispersed Phase

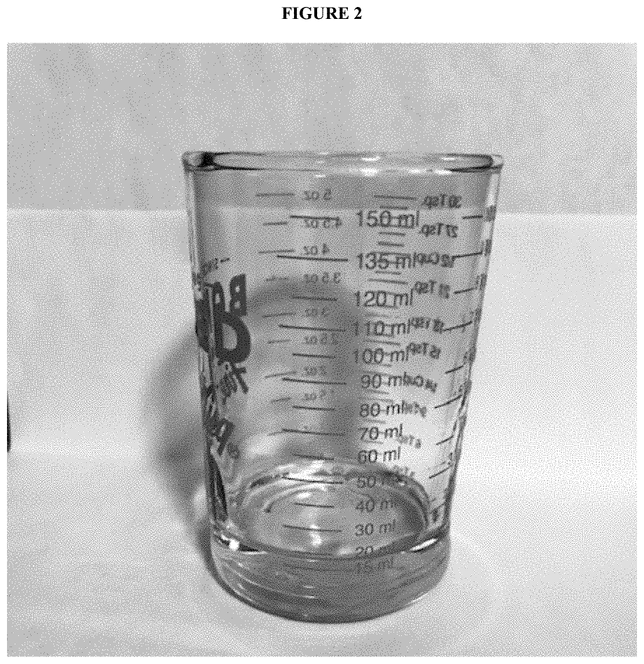

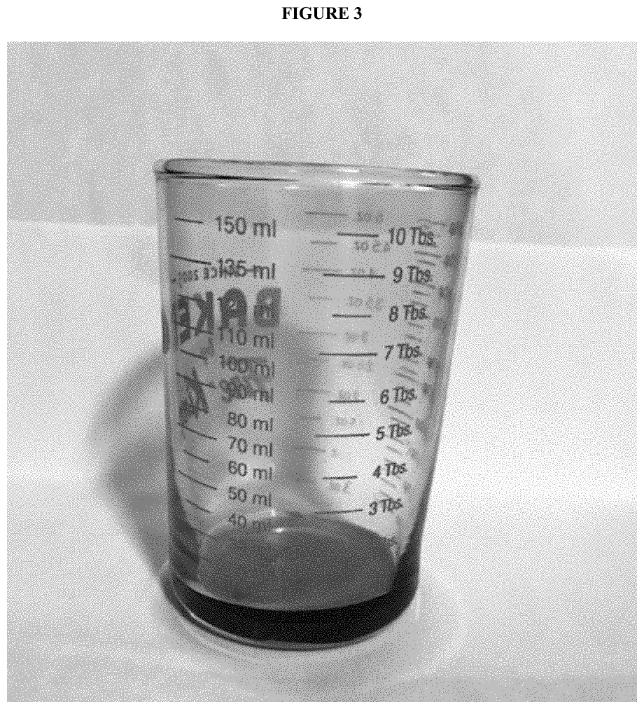

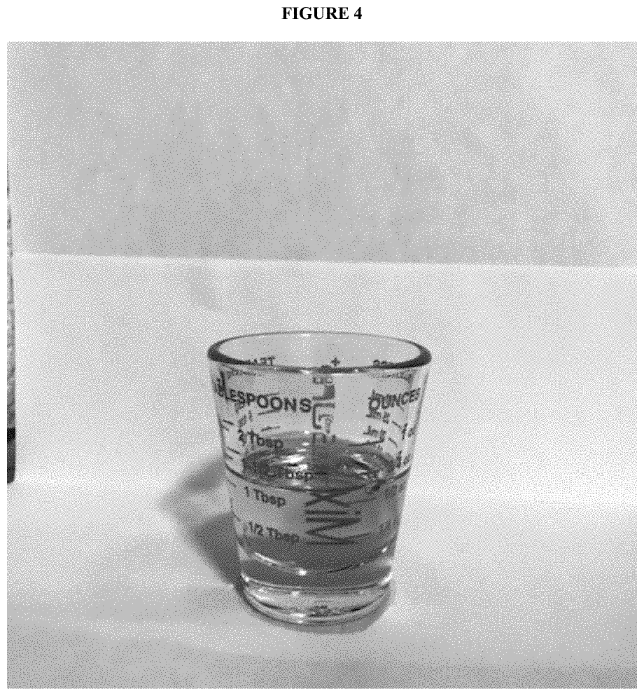

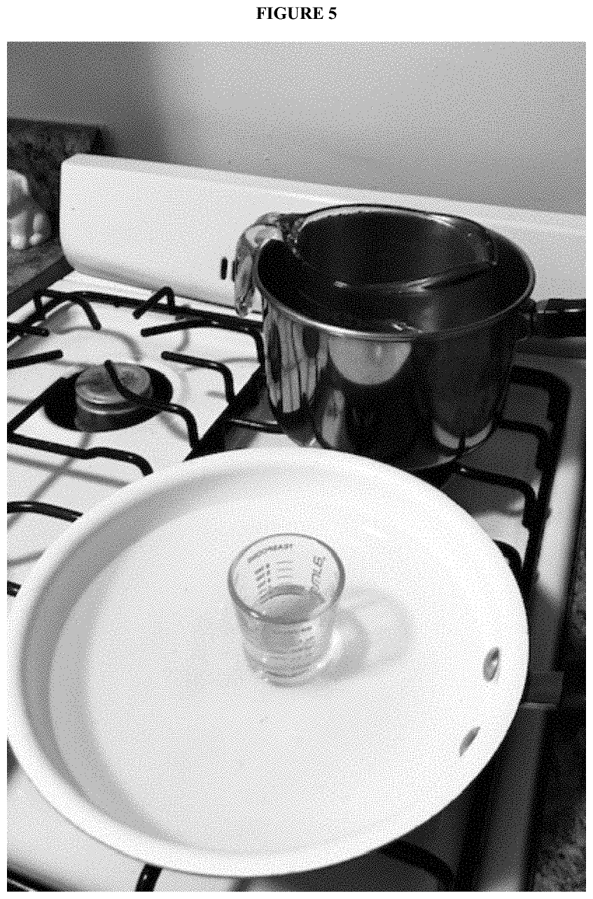

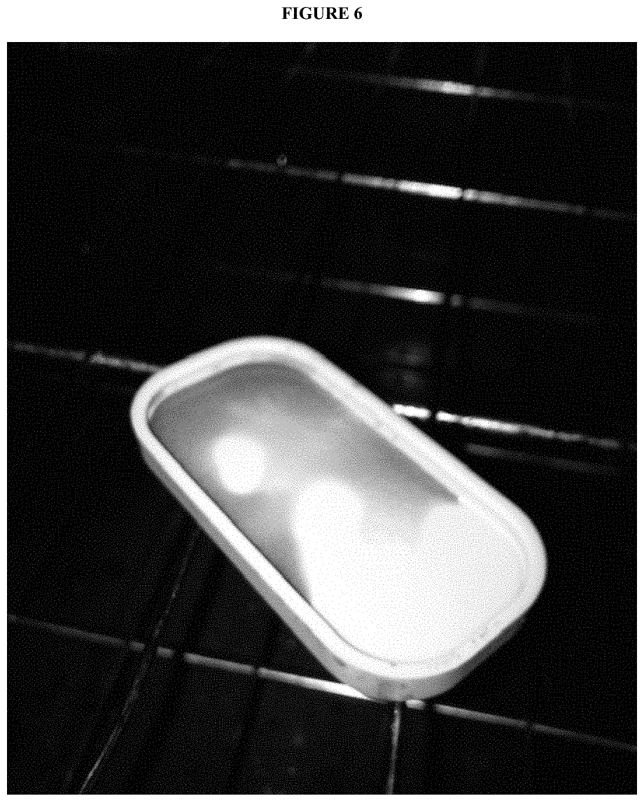

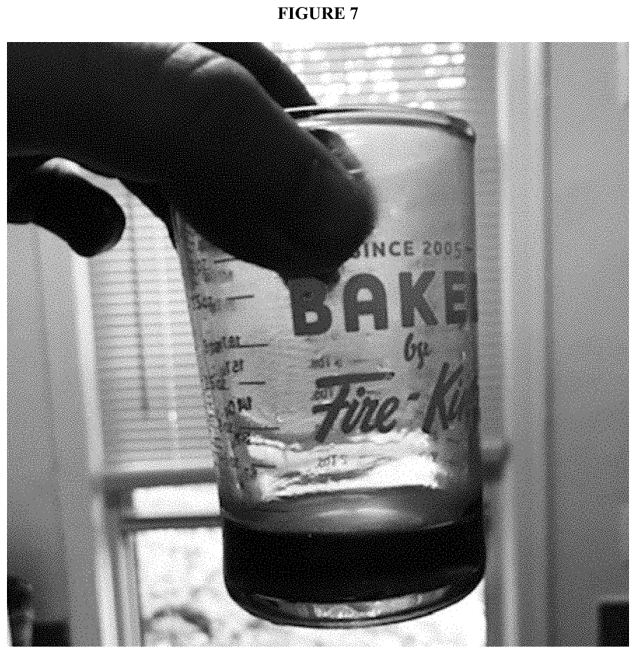

9 ml of medium-chain triglyceride oil (FIGS. 2) and 1 ml of soy lecithin (FIG. 3) were obtained. A graduated shot glass was filled with a mixture containing 9 ml of medium-chain triglyceride oil and 1 ml of soy lecithin (FIG. 4). The glass was placed in the large pot containing 500 ml of warm water and heated by the double boil method (FIG. 5) over medium heat at about 35° C.-70° C. for about 15 minutes, while the mixture was constantly stirred until the soy lecithin was completely dissolved in the medium-chain triglyceride oil. The decarboxylated cannabis extract (FIG. 6) or the decarboxylated rosin extract were then added to the mixture (FIG. 7), and the mixture was heated at about 35° C.-115° C. for about 15 minutes, while the mixture was constantly stirred until the decarboxylated cannabis extract was completely dissolved in the medium-chain triglyceride oil-emulsifier mixture and the cannabinoids were effectively encapsulated into liposomes. This step ensured that the composition have boosted bioavailability with accurate and predictable effects.

C. Oil-In-Agave Nectar Emulsion

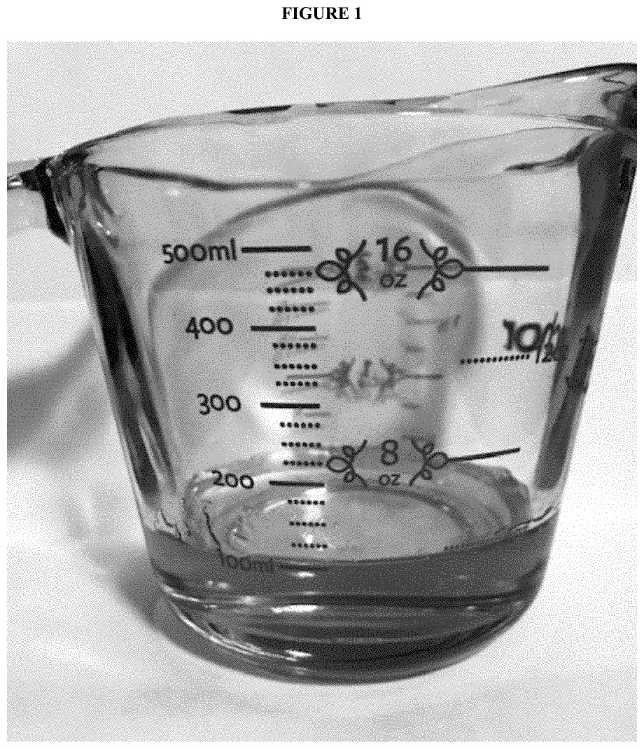

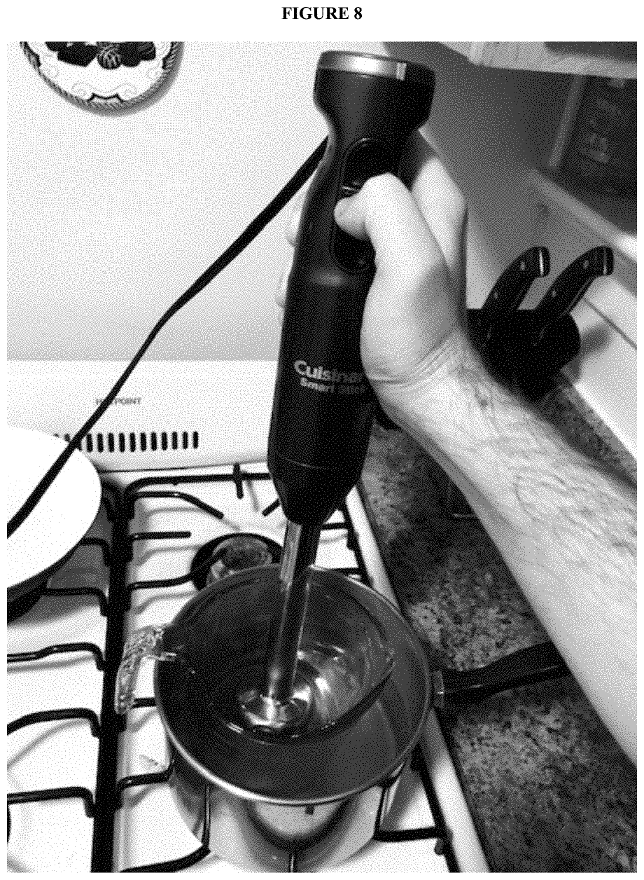

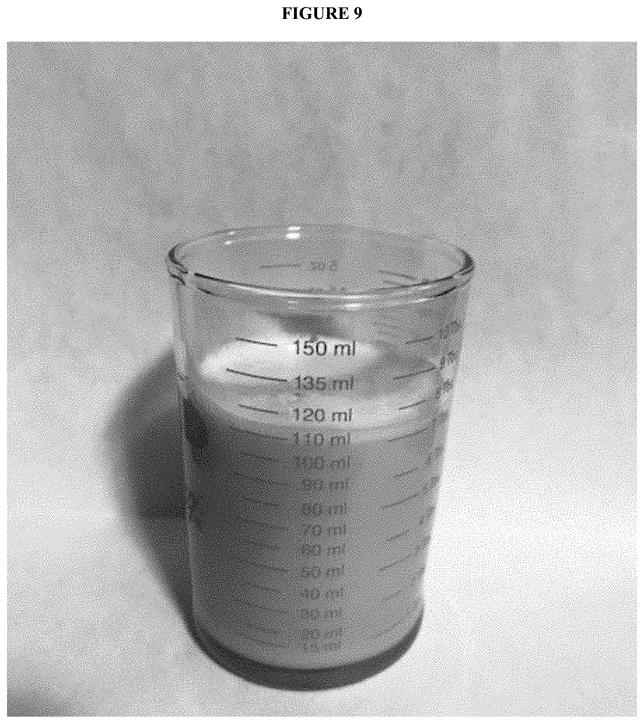

85 ml of agave syrup were placed in a graduated Pyrex measuring cup (FIG. 1), and the cup was placed in a large pot containing 500 ml of warm water and heated over medium heat at about 70° C. for about 15 minutes. The syrup was blended using an immersion blender (FIG. 8) while 15 ml of the medium-chain triglyceride oil-emulsifier mixture infused with the liposome-encapsulated cannabinoid were slowly and gradually added to the syrup, to form a cloudy and opaque emulsion having a total volume of 100 ml. The emulsion thus obtained was further blended with an immersion blender for 5 minutes at about 35° C.-70° C. to produce a stable and thorough emulsion (FIG. 9). The emulsion contained: 3% (vol/vol) of decarboxylated cannabis hydrocarbon extract; 11% (vol/vol) of medium-chain triglyceride oil; 1% (vol/vol) of soy lecithin; and 85% (vol/vol) of agave nectar.

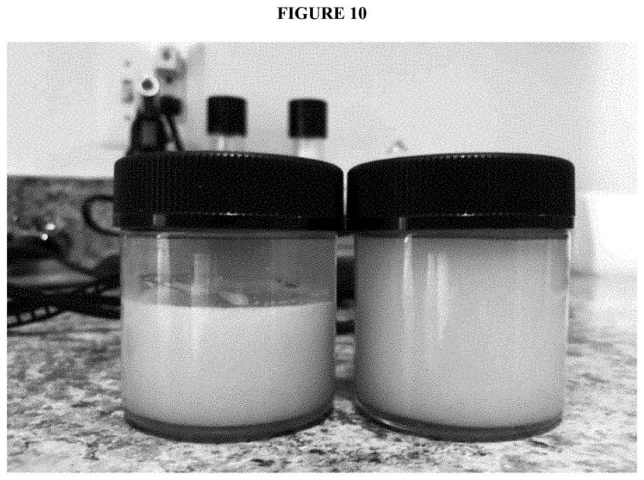

The emulsion was carefully poured into a container and cooled at room temperature. The emulsion thus prepared remained cloudy and opaque indefinitely (FIG. 10).

D. Oil-In-Honey Emulsion

80 ml of honey were placed in a graduated Pyrex measuring cup, and the cup was placed in a large pot containing 500 ml of warm water and heated over medium heat at about 70° C. for about 15 minutes. The honey was blended using an immersion blender while 17 ml of the medium-chain triglyceride oil-emulsifier mixture infused with the liposome-encapsulated cannabinoid were slowly and gradually added to the syrup, to form a cloudy and opaque emulsion having a total volume of 97 ml. The emulsion thus obtained was further blended with an immersion blender for 5 minutes at about 35° C.-70° C. to produce a stable and thorough emulsion. The emulsion contained: 1.5% (vol/vol) of decarboxylated cannabis CO₂ extract; 17% (vol/vol) of medium-chain triglyceride oil; 1.5% (vol/vol) of soy lecithin; and 80% (vol/vol) of honey. The emulsion was carefully poured into a container and cooled at room temperature. The emulsion thus prepared remained cloudy and opaque indefinitely.

E. Oil-In-Vegetable Glycerin Emulsion

60 ml of vegetable glycerin were placed in a graduated Pyrex measuring cup, and the cup was placed in a large pot containing 500 ml of warm water and heated over medium heat at about 70° C. for about 15 minutes. The glycerin was blended using an immersion blender while 40 ml of the medium-chain triglyceride oil-emulsifier mixture infused with the liposome-encapsulated cannabinoid were slowly and gradually added to the syrup, to form a cloudy and opaque emulsion having a total volume of 100 ml. The emulsion thus obtained was further blended with an immersion blender for 5 minutes at about 35° C.-70° C. to produce a stable and thorough emulsion. The emulsion contained: 10% (vol/vol) of decarboxylated solvent-less cannabis rosin extract; 26% (vol/vol) of medium-chain triglyceride oil; 4% (vol/vol) of soy lecithin; and 60% (vol/vol) of vegetable glycerin. The emulsion was carefully poured into a container and cooled at room temperature. The emulsion thus prepared remained cloudy and opaque indefinitely.

### Example 2

### Efficacy of Beverages Comprising the Disclosed Oil-In-Syrup Emulsions

Infused with Cannabinoid Microparticles

A recreational cannabinoid user orally intakes a beverage comprising the disclosed oil-in-syrup emulsion infused with microparticle-encapsulated cannabinoids once a day for a period of one month. At the end of the one-month period, the subject feels consistently relaxed and anxiety-free, and has no craving for higher cannabinoid dosages.

It should be recognized that illustrated embodiments are only examples of the disclosed product and methods and should not be considered a limitation on the scope of the invention. Rather, the scope of the invention is defined by the following claims. I therefore claim as my invention all that comes within the scope and spirit of these claims.

1. An edible, shelf-stable, water-soluble oil-in-syrup emulsion of cannabinoid microcapsules, wherein the stable oil-in-syrup emulsion comprises 0.1-49% (vol/vol) of a dispersed phase comprising 3-95% (vol/vol) of at least one oil, 0.6-94% (vol/vol) of at least one cannabinoid and 0.01-5% (vol/vol) of at least one emulsifier; and
51-99.9% (vol/vol) of a continuous phase consisting of one or more water-soluble syrup;
and wherein the stable oil-in-syrup emulsion provides extended cannabinoid release and predictable and consistent blood plasma levels of cannabinoids in a subject upon ingestion.

2. The edible, shelf-stable, water-soluble oil-in-syrup emulsion of claim 1, wherein the cannabinoid is one or more of a decarboxylated cannabis extract, a decarboxylated cannabis oil, a decarboxylated cannabis rosin, a decarboxylated cannabis resin, a decarboxylated cannabis trichome, a decarboxylated cannabis distillate, a decarboxylated cannabis isolate, delta-9-tetrahydrocannabinol, cannabidiol, cannabigerol and cannabichromene.

3. The edible, shelf-stable, water-soluble oil-in-syrup emulsion of claim 2, wherein the oil is medium-chain triglyceride oil, and wherein the medium-chain triglyceride oil is one or more of coconut oil, canola oil, hemp oil, walnut oil, palm kernel oil, vegetable oil, hempseed oil, grape seed oil, olive oil, extra virgin olive oil, avocado oil, essential oils, sunflower seed oil, sesame oil, peanut oil, palm oil, flaxseed oil, moringa oil, soybean oil, cottonseed oil, cashew oil, hazelnut oil, Brazil nut oil, fish oil, rice bran oil, diacylglycerol oil, rapeseed oil, butter, linseed oil, macadamia oil, lard, margarine, pumpkin seed oil, safflower oil, tea seed oil, tallow, mustard oil, corn oil and any combination thereof.

4. The edible, shelf-stable, water-soluble oil-in-syrup emulsion of claim 3, wherein the emulsifier is one or more of soy lecithin, sunflower lecithin, xantham gum, gum Arabic and any combination thereof.

5. The edible, shelf-stable, water-soluble oil-in-syrup emulsion of claim 4, wherein the water-soluble syrup is one or more of agave nectar, vegetable glycerin, honey, corn syrup, sorghum juice, maple syrup, glucose syrup, cane syrup, simple syrup, gum Arabic, barley malt syrup, birch syrup, brown rice syrup, chocolate syrup, fruit syrup, grape syrup, grenadine, kithul treacle, meringue, orgeat syrup, palm syrup, sharbat, stevia, sugar beet syrup, syrup of maidenhair, torani, treacle, yacon syrup, fructose, oligofructose, plant nectar, sorbitol, mannitol, xylitol, isomalt, arabitol, lacitol, xylitol, sucrose, maltitol, hydrogenated starch hydro lysates, glycerol, and any combinations thereof.

6. The edible, shelf-stable, water-soluble oil-in-syrup emulsion of claim 5, wherein the stable oil-in-syrup emulsion comprises 10-30% (vol/vol) of a dispersed phase comprising 3-95% (vol/vol) of at least one oil, 1-15% (vol/vol) of at least one cannabinoid and 0.01-5% (vol/vol) of at least one emulsifier; and 70-90% (vol/vol) of a continuous phase consisting of one or more water-soluble syrups.

7. The edible, shelf-stable, water-soluble oil-in-syrup emulsion of claim 6, wherein the stable oil-in-syrup emulsion comprises 10-20% (vol/vol) of a dispersed phase comprising 90-95% (vol/vol) of at least one oil, 1-1.5% (vol/vol) of at least one cannabinoid and 0.01-5% (vol/vol) of at least one emulsifier; and 80-90% (vol/vol) of a continuous phase consisting of one or more water-soluble syrups.

8. The edible, shelf-stable, water-soluble oil-in-syrup emulsion of claim 7, wherein the oil is fractionated coconut oil; the cannabinoid is a decarboxylated cannabis extract; the emulsifier is soy lecithin; and the water-soluble syrup is agave nectar.

9. A composition comprising the edible, shelf-stable, water-soluble oil-in-syrup emulsion of claim 1, wherein the composition is a Newtonian fluid in form of a food ingredient or a beverage.

10. The composition of claim 9, wherein the beverage is a syrup, a yogurt drink, a milk-based drink, a milkshake, an ice tea, a brewed coffee, a fruit juice, a diet drink, a soda, a sports drink, a fountain drink, a flavored water-based drink, a sparkling water drink, an infused water drink, a powdered drink mixture for dietary supplementation, an infusion, a calcium-supplemented orange juice, a sauce or a soup.

11. The composition of claim 10, wherein the cannabinoid is one or more of a decarboxylated cannabis extract, a decarboxylated cannabis oil, a decarboxylated cannabis rosin, a decarboxylated cannabis resin, a decarboxylated cannabis trichome, a decarboxylated cannabis distillate, a decarboxylated cannabis isolate, delta-9-tetrahydrocannabinol, cannabidiol, cannabigerol and cannabichromene.

12. The composition of claim 11, wherein the composition comprises 15% (vol/vol) of at least one oil, 1-1.5% (vol/vol) of at least one cannabinoid, 0.01-5% (vol/vol) of at least one emulsifier, and 80-90% (vol/vol) of one or more water-soluble syrups.

13. The composition of claim 12, wherein the oil is fractionated coconut oil;
the cannabinoid is a decarboxylated cannabis extract; the emulsifier is soy lecithin; and
the water-soluble syrup is agave nectar.

14. A kit comprising the edible, shelf-stable, water-soluble oil-in-syrup emulsion of claim 1, a container, a measuring tool and instructions for use.

15. The kit of claim 14, wherein the container is a bottle, a jar, a flask, a dispenser, a thermos, a carafe or a hermetic seal glass pitcher with a lid and spout, and wherein the measuring tool is a measuring spoon, a metered dropper pipette, a volumetric cylinder, a volumetric flask, or a measuring cup.

16. A process of preparing the edible, shelf-stable, water-soluble oil-in-syrup emulsion of claim 1, wherein the process comprises: (1) obtaining a cannabinoid; (2) mixing an emulsifier and an oil into a mixture and heating the mixture until the emulsifier is completely dissolved in the oil; (3) cooling the mixture to about 70° C.; (4) adding the cannabinoid to the mixture, and stirring the mixture until the cannabinoid is fully dissolved in the mixture; (5) heating a water-soluble syrup to a temperature from about 35° C. to about 115° C., blending the syrup and adding the mixture comprising the oil, emulsifier and cannabinoid to the syrup to produce an oil-in-syrup emulsion comprising microparticles of cannabinoids; (6) blending the emulsion for a period of time from about 5 seconds to about 10 minutes at a temperature from about 35° C. to about 115° C.; and (7) cooling the emulsion at room temperature.

17. The process of claim 16, wherein the process further comprises decarboxylating the cannabinoid by heating the cannabinoid at a temperature between about 90° C. and about 115° C. for about 20 to 2 5 minutes, and cooling the cannabinoid to a temperature between about 20° C. and 25° C. before adding the cannabinoid to the mixture comprising the emulsifier dissolved in oil.

18. The process of claim 17, wherein the water-soluble syrup and the mixture comprising the oil, emulsifier and cannabinoid are blended in a ratio of about 85:15 (vol/vol), and wherein the process further comprises adding the oil-in-syrup emulsion as a food or beverage ingredient to a composition to produce a food or beverage product.

19. A method for providing or maintaining extended release and a predictable and consistent blood plasma level of cannabinoids in a subject, wherein the method comprises orally administering to the subject the composition of claim 9.

20. The method of claim 19, wherein the subject is a cannabis recreational user or a cannabis medical user.
